(19) United States
(12) Patent Application Publication
(10) Pub. No.: US 2014/0231479 A1
(43) Pub. Date: Aug. 21, 2014

(54) AERODYNAMIC WATER BOTTLE MOUNTING SYSTEM

(71) Applicant: David VanZanten, Las Vegas, NV (US)

(72) Inventor: David VanZanten, Las Vegas, NV (US)

(21) Appl. No.: 14/179,424

(22) Filed: Feb. 12, 2014

Related U.S. Application Data
(60) Provisional application No. 61/765,473, filed on Feb. 15, 2013.
(60) Provisional application No. 61/907,139, filed on Nov. 21, 2013.

(51) Int. Cl. B62J 11/00

(52) U.S. Cl. CPC B62J 11/00
USPC 224/441; 224/414

(57) ABSTRACT

An apparatus for mounting a water bottle to the aero bars of a bicycle in an aerodynamic position is provided. The aero bars include a first extending bar portion and a second extending bar portion. The apparatus includes a front mechanism and a rear mechanism. The front mechanism has a front base portion and first and second front tethering portions. The front base portion receives a top portion of the water bottle. The first and second front tethering portions are removably coupled to the first and second extending bar portions, respectively. The rear mechanism has a rear base portion and first and second rear tethering portions. The rear base portion receives a bottom end of the water bottle. The rear tethering portion is removably coupled to the first and second extending bar portions.

### CROSS-REFERENCE TO RELATED APPLICATION

This application claims priority U.S. Provisional Patent Application No. 61/765,473, filed Feb. 15, 2013, and U.S. Provisional Patent Application No. 61/907,139, filed Nov. 21, 2013, the disclosures of which are hereby incorporated by reference in their entirety.

### TECHNICAL FIELD

I, David Scott VanZanten, have invented an aerodynamic water bottle mounting system. The invention will allow bike racers and others wishing to achieve maximum aerodynamic efficiency a way to mount their water bottle or similar gear horizontally without worry of the item sliding out of its holder if the rider hits a bump or pothole or makes a sudden stop.

### BACKGROUND OF THE INVENTION

Keeping hydrated is always very important during any type of strenuous exercise. In biking, water bottles are typically carried using a water bottle holder or carrier which is typically made of a metal cage mounted via screws to the frame of the bicycle, such as below the top tube, down tube, or seat tube.

Such case are heavy, require screws to mount the cage to the frame, and place the water bottle in a position from which it is awkward and/or dangerous for the rider to remove the bottle to drink water from the bottle. Additionally, such traditional placement positions the water bottle in a non-aerodynamic position.

The present invention is aimed at one or more of the problems identified above.

### SUMMARY OF THE INVENTION

In a first aspect of the present invention, an apparatus for mounting an item to a bicycle in an aerodynamic position is provided. The apparatus includes a front mechanism and a rear mechanism. The front mechanism has a front base portion and a front tethering portion. The front base portion is formed to receive a first end of the item. The front tethering portion is removably coupled to a mounting portion of the bicycle. The rear mechanism has a rear base portion and a rear tethering portion. The front base portion is formed to receive a second end of the item. The rear tethering portion is removably coupled to a mounting portion of the bicycle.

In a second aspect of the present invention, an apparatus for mounting a water bottle to the aero bars of a bicycle in an aerodynamic position is provided. The aero bars include a first extending bar portion and a second extending bar portion. The apparatus includes a front mechanism and a rear mechanism. The front mechanism has a front base portion and first and second front tethering portions. The front base portion receives a top portion of the water bottle. The first and second front tethering portions are removably coupled to the first and second extending bar portions, respectively. The rear mechanism has a rear base portion and first and second rear tethering portions. The front base portion receives a bottom end of the water bottle. The rear tethering portion is removably coupled to the first and second extending bar portions.

### BRIEF DESCRIPTION OF THE DRAWINGS

FIG. 1A is a first view of an apparatus for mounting an item to a bicycle, according to an embodiment of the present invention;

FIG. 1B is a second view of the apparatus of FIG. 1A;

FIG. 2A is a first view of an apparatus for mounting an item to a bicycle, according to a second embodiment of the present invention;

FIG. 2B is a second view of the apparatus of FIG. 2A;

FIG. 3A is a first view of an apparatus for mounting an item to a bicycle, according to a third embodiment of the present invention;

FIG. 3B is a second view of the apparatus of FIG. 3A;

FIG. 4A is a first view of an apparatus for mounting an item to a bicycle, according to a fourth embodiment of the present invention;

FIG. 4B is a second view of the apparatus of FIG. 4A;

FIG. 5 is a view of a tethering portion, according to an embodiment of the present invention;

FIG. 6 is a second view of the tethering portion of apparatus of FIG. 5; and,

FIG. 7 is a third view of the tethering portion of apparatus of FIG. 5.

### DETAILED DESCRIPTION

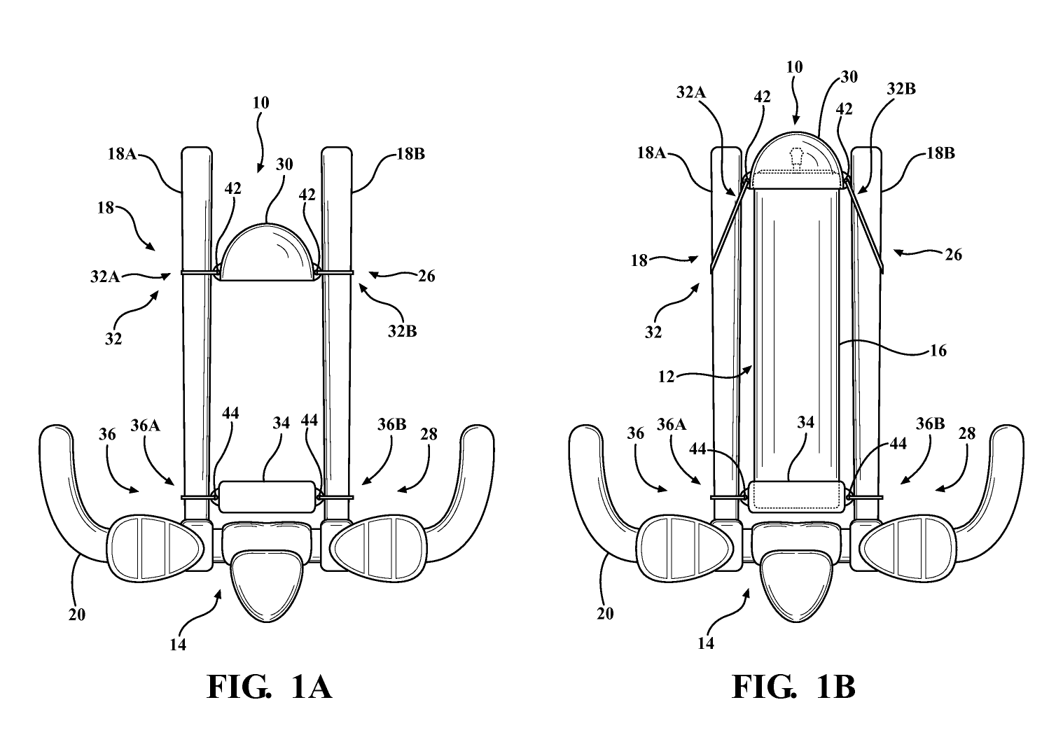

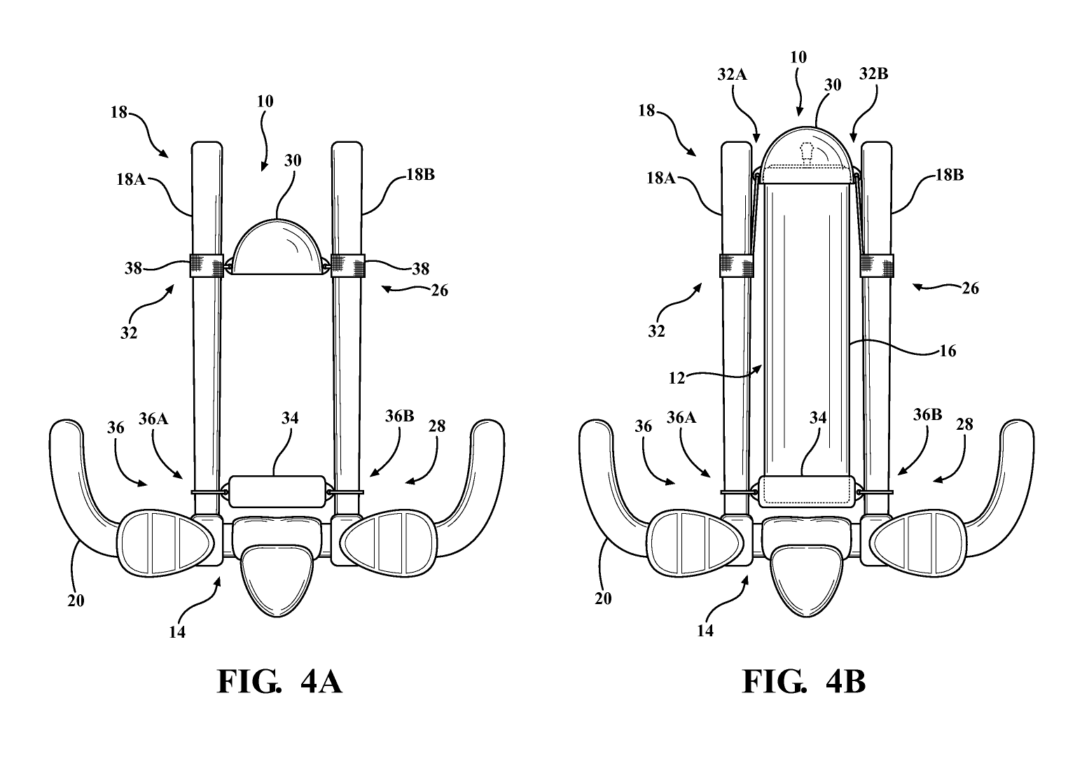

With reference to the drawings, and in operation, an apparatus 10 for releasably mounting an item 12 to a bicycle 14 is provided. For example, the item 12 may be a water bottle 16, as shown in FIGS. 1B, 2B, 3B, and 4B. However, the item 12 could be other items, such as a tool kit, or carrying pouch or container (not shown).

In one embodiment, the apparatus 10 may be coupled to a set of aerobars 18 which extend from a set of handlebars 20 of the bicycle 14.

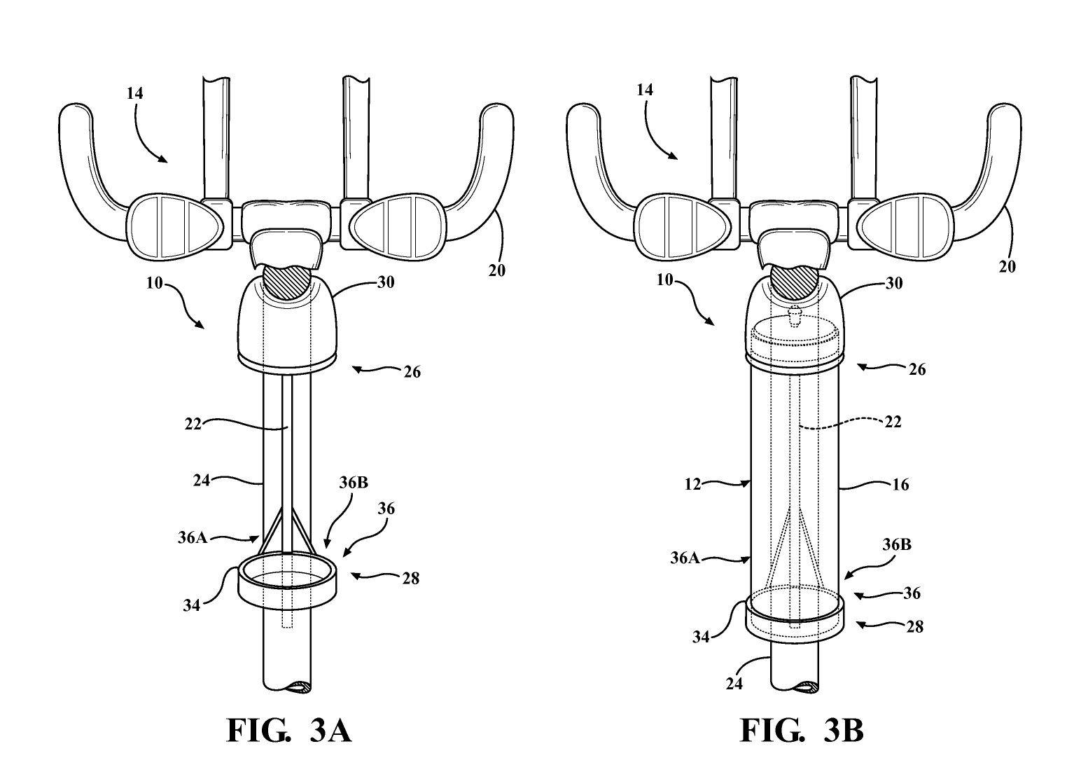

In another embodiment of the invention, the apparatus 10 may be mounted to a mounting bracket 22 (see FIGS. 3A and 3B). In the illustrated embodiment, the mounting bracket 22 is located above and along a top tube 24 of the bicycle's frame (not shown).

Other mounting devices and/or locations may also be used.

The apparatus 10 includes a front mechanism 26 and a rear mechanism 28. It should be noted that the terms “front” and “rear”, at least in some of the disclosed embodiments refer to a positions which are “rear” towards and in “front” of the “rear” position relative to a rider. However, this terminology is not intended to be limiting with respect to the positions of specific elements relative to the rider's position, but only provided for purposes of explanation and convenience.

The front mechanism 26 includes a front base portion 30 and a front tethering portion 32. The front base portion 30 is formed to receive a first end of the item 12 or water bottle 16. The front tethering portion 32 is removably coupled to a mounting portion of the bicycle 14.

The rear mechanism 28 includes a rear base portion 34 and a rear tethering portion 36. The rear base portion 34 is formed to receive a second end of the item 12 or water bottler 16. The rear tethering portion 36 is removably coupled to a mounting portion of the bicycle 14.

As will be explained in more detail, at least one of the front and rear tethering portions 32, 36 are elastic. The other one of the front and rear tethering portions 32, 36, in one embodiment, is flexible, but either inelastic or only slightly elastic. In another embodiment, the other one of the front and rear tethering portions 32, 36 are also elastic.

In several embodiments of the present invention, the apparatus 10 is mounted to a set of aerobars 18. As shown in FIG. 1A, the set of aerobars 18 includes a first extending bar portion 18A and a second extending bar portion 18B which are mounted to, and extend away from, the handlebars 20.

In one embodiment, the front mechanism 26 includes the front base portion 30 and at least one separate front tethering portion 32. For example, as illustrated in FIGS. 1A and 1B, the apparatus 10 is mounted to the aerobars 18 as discussed above. The front base portion 30 is a separate piece, which in the illustrated embodiment may be conical or partially spherical in shape (as shown). The front base portion 30 has at least one aperture 42. In the illustrated embodiment, the front mechanism 26 includes two apertures 42 located on opposite sides of the front base portion 30. A first front tethering portion 32A, is threaded through one of the apertures 42 and slipped over the first extending bar portion 18A. A second front tethering portion 32B is threaded through the other one of the apertures 42 and slipped over the second extending bar portion 18B.

In one embodiment, the rear mechanism 28 includes the rear base portion 34 and at least one separate rear tethering portion 36. For example, as illustrated in FIGS. 1A and 1B, the apparatus 10 is mounted to the aerobars 18 as discussed above. The rear base portion 34 is a separate piece, which in the illustrated embodiment is cup shaped (as shown). The rear base portion 34 has an aperture 44. In the illustrated embodiment, the rear mechanism 28 includes two apertures 44 located on opposite sides of the rear base portion 34. A first rear tether portion 36A, is threaded through one of the apertures 44 and slipped over the first extending bar portion 18A. A second rear tether portion 36B is threaded through the other one of the apertures 44 and slipped over the second extending bar portion 18B.

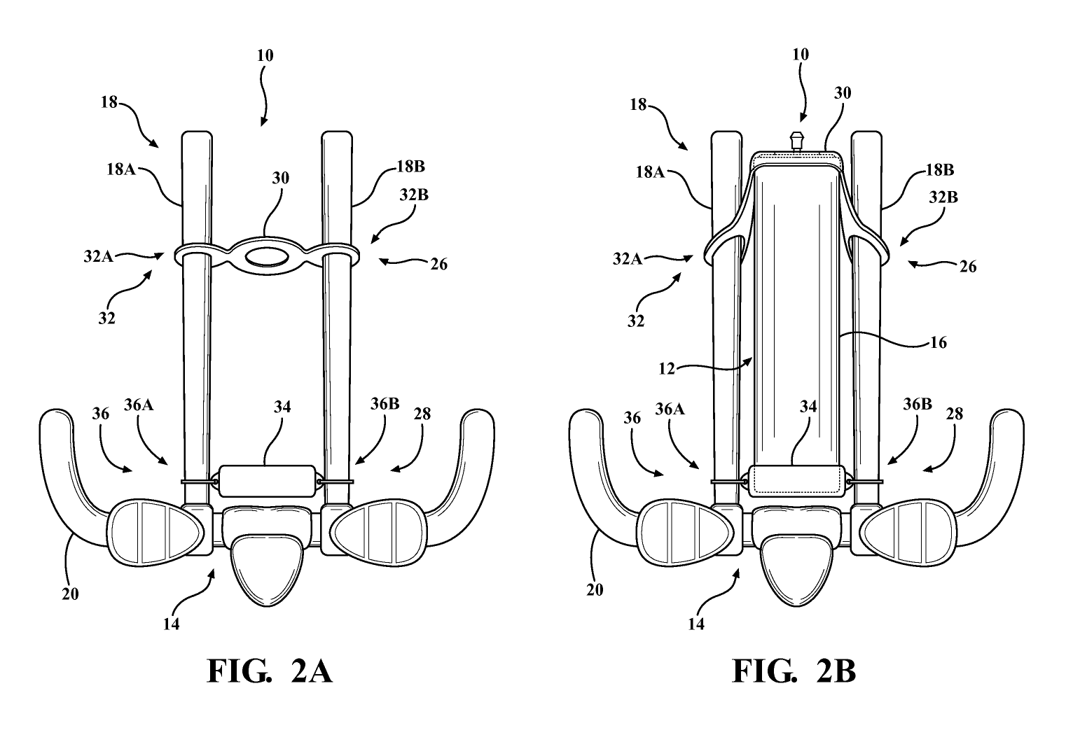

In a second embodiment, as shown in FIGS. 2A and 2B, the front mechanism 26, include the front base portion 30 and the front tethering portion(s) 32 may be unitarily formed. The front base portion 30 may be bowl-shaped, cone-shaped, or donut-shaped in order to receive one of the ends of the item 12 or water bottle 16. As shown in FIG. 2B, the donut shaped front base portion 30 has an aperture 42, 44 which allows the mouthpiece of the water bottle 16 to extend therethrough. The one piece front mechanism 26 of FIGS. 2A, 2B, has one or more apertures 42A through which the aerobars 18 are slipped through.

It should be noted that in the embodiment, shown in FIGS. 2A and 2B, the rear mechanism 28 is shown as having multiple pieces as in the embodiment of FIGS. 1A and 1B. However, it should be noted that the rear mechanism 28 may be unitarily formed as the front mechanism 26 of FIGS. 2A and 2B.

With reference to FIG. 3A, in another embodiment of the present invention, each of the front and rear mechanisms 26, 28 are mounted to the bicycle 14 at a single point. In this embodiment, one of the front and rear mechanisms 26, 28 is fixedly mounted to a mounting bracket 22 which is mounted to the bicycle 14. In the illustrated embodiment, the front mechanism 26 is fixedly mounted near the front end of the top bar 24 of the bike frame. In this embodiment, the rear mechanism 28 slides along the mounting plate via the rear tether portions 36A, 36B.

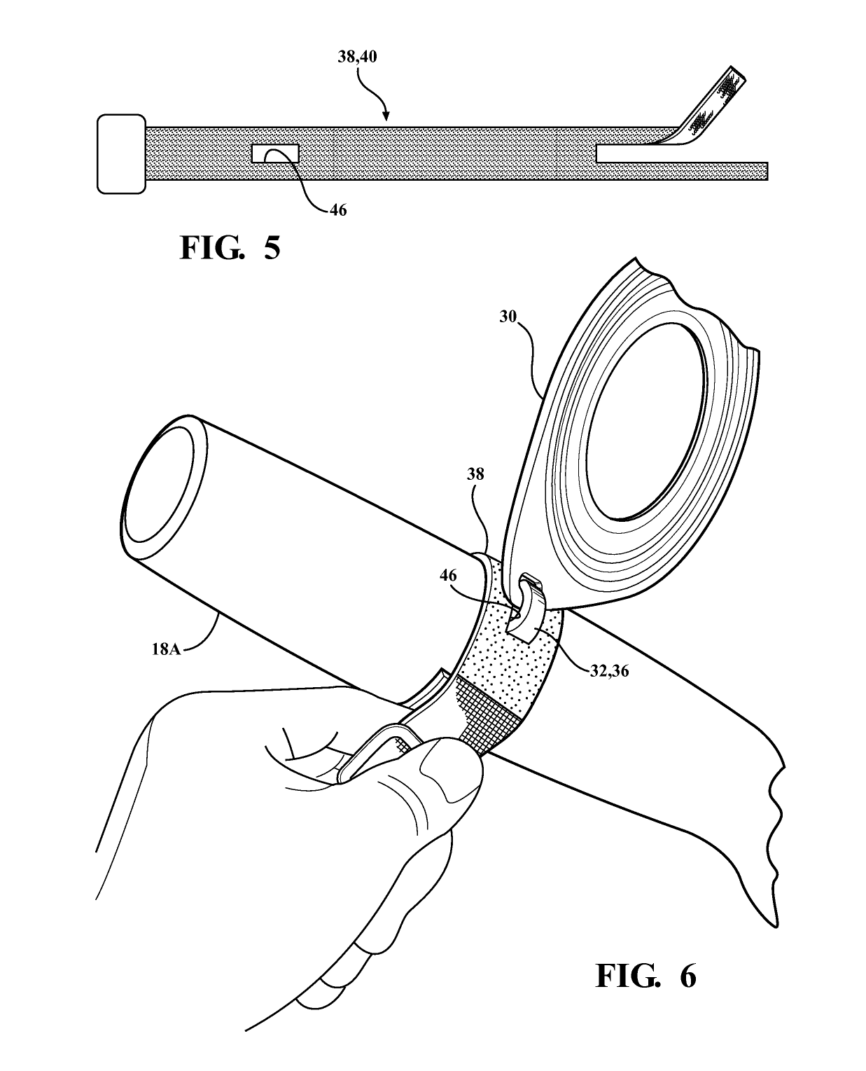

With reference to FIGS. 5, 6, and 7 in one embodiment, the apparatus 10 may include one or more tethering stays 38, 40 which are used to wrap around the tethering portions 32, 36 and a portion of the bicycle 14, e.g., the aerobars 18, to maintain the tethering portion 32, 36 in place.

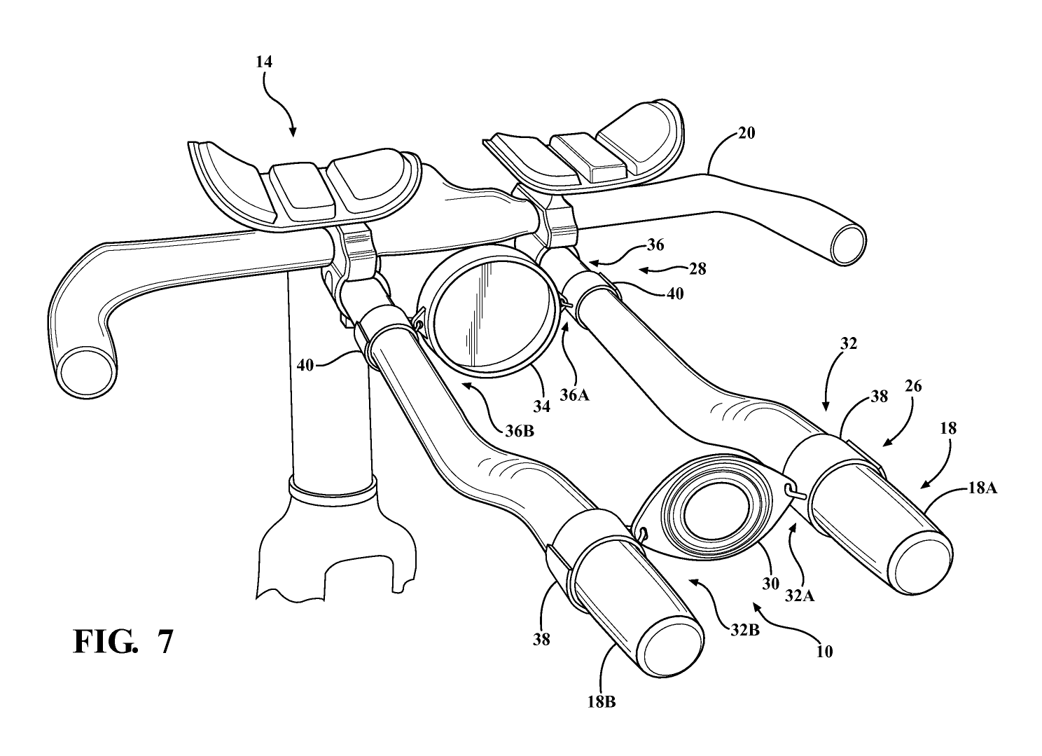

With particular reference to FIG. 5, the stays 38, 40 are composed of a flexible, but generally non-elastic, material and fastened with Velcro or similar hook/loop fastener. In the illustrated embodiment the stays 38, 40 have a rectangular hole 46. To maintain the tethering portions 32, 36 in place, the stays 38, 40 may be wrapped around the tethering portion 32, 36 and the aerobar 18, for example. The tethering portion 32, 36 may be fit through the hole 46 as shown in FIG. 6 such that when the stays 38, 40 are secured around the aerobar 18, the tethering portion 32, 36 remains in place. In one embodiment, as shown in FIG. 7 first and second front tethering stays 38 and first and second rear tethering stays 40 are used.

### INDUSTRIAL APPLICABILITY

In use and in operation, the apparatus 10 of the present invention may be used to securely and removably secure an item 12, such as a water bottle 16, to a bicycle 14. As shown in the FIGS., the front base portion 30 may be bowl shaped, cone shaped or ring shaped to secure the top portion of the water bottle 16. The front mechanism 26 may be secured to the aerobars 18 of a time trial or triathlon bicycle using the front tethering portions 32, which normally have elastic properties to have a spring-like effect to connect the water bottle 16 with the rear mechanism 28. The front mechanism 26, or at least the front tethering portions 32 are composed of an elastic material, such as latex.

In one embodiment, the rear mechanism 28 does not stretch (or are minimally elastic). For example, the rear mechanism 28 or the rear tethering portions 36 may be comprised of a plastic or comprised from Velcro (or similar hook/loop fastener) straps or plastic ties. However, it should be noted that the orientation may be reversed such that the front mechanism 26 is rigid or relatively rigid and the rear mechanism 28 has elastic properties.

FIG. 1A shows the apparatus 10 before a water bottle 16 has been inserted, and FIG. 1B shows the apparatus 10 after a water bottle 16 has been inserted.

FIGS. 2A and 2B show a unitarily formed front mechanism 26. The front mechanism 26 is used to secure the front of the water bottle 16. The front mechanism of FIGS. 2A and 2B has elastic characteristics. The front mechanism may be composed from latex or similar material. The rear mechanism 28 operates in a manner to the rear mechanism 28 of FIGS. 1A and 1B.

FIGS. 3A and 3B show a front mechanism 26 and rear mechanism 28 mounted on the mounting bracket 22. The mounting bracket 22 is attached to the top bar 24 of the bike frame. Normally, the front mechanism 26 will be fixed in place near the head tube of the bike frame for aerodynamic efficiency. The rear mechanism 28 is capable of sliding along the mounting bracket 22, and is further attached to the mounting bracket 22 using the rear tethering portions 32.

As depicted in FIGS. 1A and 1B, to use, the user takes the head/top portion of the water bottle 16 and inserts it into the front mechanism 26. The configuration of the front tethering portions 32 may make it easier for the user by having the front mechanism 26 tilted upward or at an angle toward the user sitting on the bicycle 14. Once the head of the water bottle 16 has been inserted into the front mechanism 26, the user pushes the water bottle 16 forward slightly to clear the top edge of the rear mechanism 28 as the water bottle 16 is also pushed downward. The elasticity of the tethering portions 32 push the water bottle 16 backward, where the user guides the bottom of the water bottle 16 into the rear mechanism 28. The rear tethering portions 36 hold the water bottle 16 in place. The water bottle 16 now is captured cannot slide forward/backward/up/down/sideways.

Similarly, in FIGS. 2A and 2B, the user pushes the water bottle's 16 head into the 1-piece front mechanism 26, which may be shaped as a bowl or a ring or a cone as in FIGS. 1A and 1B, or it may be a flat piece with a hole large enough for the pull spout of the water bottle 16 to easily fit through, but smaller than the head of the water bottle 16 to restrain the water bottle 16.

In the configuration for FIGS. 3A and 3B, the user guides the bottom of the water bottle 16 into the rear mechanism 28 and pulls the water bottle 16 backward until the pull spout and top of the water bottle 16 can be inserted into the front mechanism 26. The elasticity of the rear tethering portions 36 then slide the rear mechanism 28 forward on the track created by the mounting bracket 22.

The system can be reversed such that in FIGS. 1A and 1B and FIGS. 2A and 2B, the rear tethering portions 36 are elastic, while the front tethering portions 32 are not elastic (or are only slightly elastic). Alternatively, the front and the rear tethering portions 32, 36 may have elastic properties.

Alternatively, the tethering portions 32, 36 can be in elastic (such as cable ties), but the compression function to push the front mechanism 26 and/or rear mechanism 28 together can be achieved by a spring mounted inside thereof (not shown). Or, a spring-like material (e.g., polyurethane foam) can be placed into the mechanism(s) 26, 28.

Also, a strap with a hook attached to it can be fashioned around the water bottle 16 before the water bottle 16 is used. The hook may function as a ‘catch,’ most likely attaching to a mounting harness with elastic properties, e.g., the water bottle's 16 attached hook catches the front mechanism 26 between the aerobars 18; or, the water bottle's 16 hook catches the rear mechanism 28 to simplify the mounting mechanisms 26, 28.

This written description uses examples to disclose the invention, and also to enable any person skilled in the art to practice the invention, including making and using any devices or systems and performing any incorporated methods. The patentable scope of the invention is defined by the claims, and may include other examples that occur to those skilled in the art. Other aspect and features of the present invention can be obtained from a study of the drawings, the disclosure, and the appended claims. The invention may be practiced otherwise than as specifically described within the scope of the appended claims.

Although specific features of various embodiments of the invention may be shown in some drawings and not in others, this is for convenience only. In accordance with the principles of the invention, any feature of a drawing may be referenced and/or claimed in combination with any feature of any other drawing.

### LIST OF COMPONENT NUMERALS

10 apparatus
12 item
14 bicycle
16 water bottle
18 aerobars
18A first extending bar portion
18B second extending bar portion
20 handlebars
22 mounting bracket
24 top bar
26 front mechanism
28 rear mechanism
30 front base portion
32 front tethering portion
32A front tethering portion
32B front tethering portion
34 rear base portion
36 rear tethering portion
36A rear tethering portion
36B rear tethering portion
38 front tethering stay
40 rear tethering stay
42 aperture in the front base portion
42A aperture in the front base portion
44 aperture in the rear base portion
46 rectangular hole in the stays

What is claimed is:

1. An apparatus for mounting an item to a bicycle in an aerodynamic position, comprising:
a front mechanism having a front base portion and a front tethering portion, the front base portion being formed to receive a first end of the item, the front tethering portion being removably coupled to a mounting portion of the bicycle; and,
a rear mechanism having a rear base portion and a rear tethering portion, the rear base portion being formed to receive a second end of the item, the rear tethering portion being removably coupled to a mounting portion of the bicycle, wherein at least one of the front and rear tethering portions are elastic.

2. An apparatus, as set forth in claim 1, the mounting portion is a mounting bracket.

3. An apparatus, as set forth in claim 1, wherein the mounting portion of the bicycle is a set of aerobars.

4. An apparatus, as set forth in claim 1, wherein the front base portion has an aperture, the front tethering portion being elastic and being located in the aperture and around the mounting portion of the bicycle.

5. An apparatus, as set forth in claim 4, further comprising a front tethering stay configured to clamp onto the mounting portion of the bicycle and around the front tethering portion to maintain the front tethering portion in place on the mounting portion.

6. An apparatus, as set forth in claim 5, wherein the rear base portion and the rear tethering portion are unitarily formed.

7. An apparatus, as set forth in claim 6, further comprising a rear tethering stay configured to clamp onto the mounting portion of the bicycle and around the rear tethering portion to maintain the rear tethering portion in place on the mounting portion.

8. An apparatus, as set forth in claim 5, wherein the rear base portion has a rear aperture, the rear tethering portion being located in the rear aperture and around the mounting portion.

9. An apparatus, as set forth in claim 8, further including a rear tethering stay configured to clamp onto the mounting portion of the bicycle and around the rear tethering portion to maintain the rear tethering portion in place on the mounting portion.

10. An apparatus, as set forth in claim 1, wherein the front base portion and the front tethering portion are unitarily formed.

11. An apparatus, as set forth in claim 10, further comprising a front tethering stay configured to clamp onto the mounting portion of the bicycle and around the front tethering portion to maintain the front tethering portion in place on the mounting portion.

12. An apparatus, as set forth in claim 10, wherein the rear base portion and the rear tethering portion are unitarily formed.

13. An apparatus, as set forth in claim 12, further comprising a rear tethering stay configured to clamp onto the mounting portion of the bicycle and around the rear tethering portion to maintain the rear tethering portion in place on the mounting portion.

14. An apparatus, as set forth in claim 9, wherein the rear base portion has a rear aperture, the rear tethering portion being located in the rear aperture and around the mounting portion.

15. An apparatus, as set forth in claim 14, further including a rear tethering stay configured to clamp onto the mounting portion of the bicycle and around the rear tethering portion to maintain the rear tethering portion in place on the mounting portion.

16. An apparatus, as set forth in claim 1, wherein the item is a water bottle, and the front base portion is shaped to secure to a top portion of the water bottle.

17. An apparatus, as set forth in claim 16, wherein the front base portion is one of bowl-shaped, cone-shaped, or donut-shaped.

18. An apparatus, as set forth in claim 17, wherein the rear base portion is cup-shaped to receive the second end of the water bottle.

19. An apparatus for mounting a water bottle to the aero bars of a bicycle in an aerodynamic position, the aero bars include a first extending bar portion and a second extending bar portion, comprising:
a front mechanism having a front base portion and first and second front tethering portions, the front base portion being formed to receive a top portion of the water bottle, the first and second front tethering portions being removably coupled to the first and second extending bar portions, respectively; and,
a rear mechanism having a rear base portion and first and second rear tethering portions, the rear base portion being formed to receive a bottom end of the water bottle, the rear tethering portion being removably coupled to the first and second extending bar portions, wherein at least one of (1) the first and second front tethering portions and (2) the first and second rear tethering portions are elastic.
